(19) United States
(12) Patent Application Publication
(10) Pub. No.: US 2009/0112870 A1
(43) Pub. Date: Apr. 30, 2009

(54) MANAGEMENT OF DISTRIBUTED STORAGE

(75) Inventors: Raymond E. Ozzie, Seattle, WA (US); George P. Moromisato, Seattle, WA (US); Anthony Dean Andrews, Sammamish, WA (US); William D. Devlin, Sammamish, WA (US); Akash J. Sagar, Redmond, WA (US); William Michael Zintel, Woodinville, WA (US); Dharma K. Shukla, Sammamish, WA (US); Abolade Gbadegesin, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/931,726

(22) Filed: Oct. 31, 2007

(51) Int. Cl. G06F 17/30

(52) U.S. Cl. 707/9; 707/103 R; 707/E17.12; 707/E17.055

(57) ABSTRACT

Systems and methods of distributed storage are disclosed herein. A request to store data in a client computer is received. A request is sent from the client computer to a storage service to create a core object such that the core object can be created with a member entry to a member feed in the core object. The member feed can be indicative of one or more entities that are permitted to access to the core object. A message is received at the client computer with the core object. A replica of the core object on the client computer is created. The client computer can add the data as a data entry to a data feed in the core object. An updating message is sent to the storage service. The message can include a copy of the replica of the core object including the data entry.

### BACKGROUND

Traditional storage systems are not well-suited to a world in which users access the same data from multiple devices, store such data both locally and on a computer network (e.g. the Internet), and share such data with other users who also have multiple devices. Storing data on a local file system (as traditional applications do) makes the data available quickly without having to connect to a computer network. However, it is challenging for a user to share such data and is tied to a specific piece of physical hardware. Conversely, storing data in the on a computer network makes the data easy to share—but access to the computer network is required.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Described herein are various techniques and technologies directed to permitting data storage on a computer network, and on local devices, such that data can be replicated to multiple devices and accessible to multiple users, both locally and via a network. Core objects are also disclosed herein as storage units that are replicated to user devices, and to members of groups permitted to access a given piece of data.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates a component diagram of a system for managing a distributed storage according to one embodiment.

FIG. 2 illustrates a component diagram of a storage service according to one embodiment.

FIG. 3 illustrates an exemplary data structure for a core object according to one embodiment.

FIG. 4 illustrates a flow diagram of a process for creating and storing a core object according to one embodiment.

FIG. 5 illustrates a flow diagram of a process for creating and storing a core object according to another embodiment.

FIG. 6 illustrates a component diagram of a computing device for implementing one or more embodiments.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented as a system for managing preferred items lists in the context of products, it is also contemplated the a preferred item may be a service that the consumer wants to receive. As such, the system described is provided as an example and not a limitation. As those skilled in the art will appreciate, the present examples are suitable for application in a variety of different types of preferred items list management.

Described herein are various techniques and technologies directed toward an implementation of storing data persistently and redundantly across various devices of a network, and for access of various members of a group. The data can be stored in storage units referred to herein as a core object. As used herein, a core object is a globally unique data storage unit that contains data, that can be accessed by a set of members, and that is mapped to a set of devices. A core object can have a design that describes how the user can interact with the data (including an URL to the application that is best suited to interact with the core object). Although the data for a core object is stored and replicated across one or more devices, the metadata for the core object can be stored in a single central store service. In addition, as utilized herein, a member is user that is permitted to access a specific core object with a predetermined level of privileges.

As such, the present systems and methods permit a user to have the data stored persistently and always available online, offline, at home, at work, at any networked endpoint, and the like. Core objects include feeds, which are discrete sets of data that may or may not be replicated among other devices storing the same core object. For instance, a core object that is stored and replicated in association with a first member and a second member may only be replicated partially from one the first member to the second member. In other words, personal data of the first member, for example, would not be replicated to the second member, but shared data within the same core object could be replicated to the second member.

Feeds can be implemented using ATOM or RSS technology, or any other syndication technology now known or to become known. In addition, feeds can include enclosures that store data. These and other features will be described below in more detail.

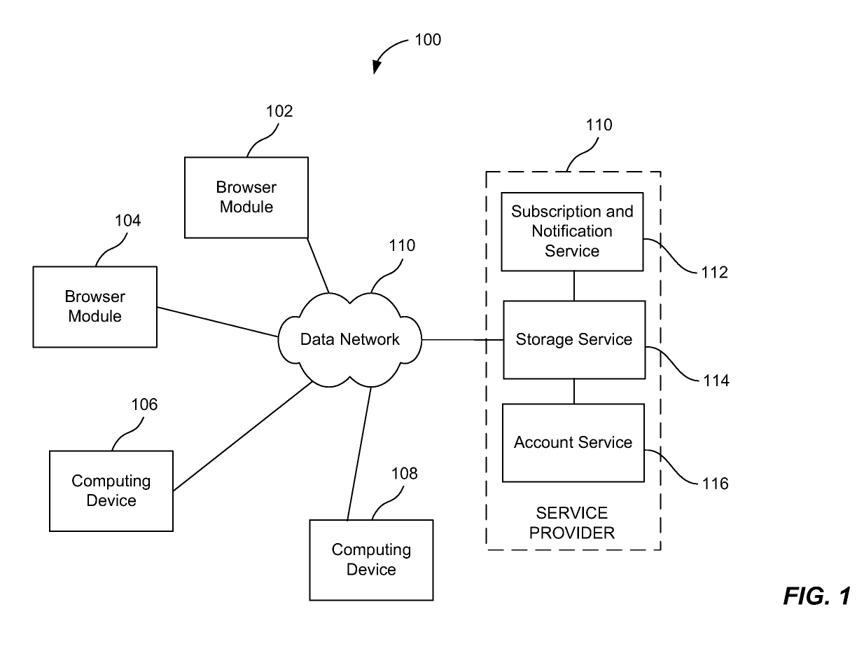

FIG. 1 illustrates a component diagram of a system for managing a distributed storage according to one embodiment. The storage system 100 disclosed herein permits the redundant storage of data in multiple locations of a network. For example, multiple computing devices, both physical and logical, can store the same data in a core object. A service provider 110 can implement an infrastructure that includes a subscription and notification server 112, a storage service 114, and an account service 116.

In one embodiment, the storage service 114 can be a single logical service with the ability to store core objects. In one example, the storage service 114 can service web-base applications. Exemplary browser modules 102 and 104 can be utilized by users to access the storage service 114, and through subscription and notification services 112 receive the experience of storing data on the data network 110. In another example, the storage service 114 can service applications residing on a computing device, such as computing device 106 and 108.

In the storage system 100 disclosed herein, one or more storage services are contemplated. As such, a central service or aggregation of servers can constitute one or more storage services. In one example, the service provider 110 can be an enterprise, such as a company, can own a computer infrastructure that implements a storage service 114. In another example, an enterprise can own multiple storage services.

The service provider 110 can include a subscription and notification server 112. The subscription and notification server 112 can provide applications a set of feeds to which an application can subscribe. Furthermore, the service provider 110 can also include an account service 116. The account service 116 can permit applications to set storage services for an entity such as an individual user, groups, etc.

As previously mentioned, the storage service 110 can utilize a data structure, such as the core object data structure disclosed herein in order to store and/or replicate data. Core objects can be utilized by computer applications, or web-based applications, to store data as necessary. Therefore, applications can be configured to store data appropriately according to the purpose of the data. In one example, an application can be configured to store shared data of the core object among all entities (such as individual users, user groups, etc.) that are provided with permission to access such data. In another example, an application can be configured to distribute personal data of an entity to all the devices for the member that is the owner of the data, not other members or persons.

In one embodiment, the core objects in a storage service 114 can be addressable by a Uniform Resource Identifier (URI). In one embodiment, the storage service 114 only stores metadata of a core object, while the data can be stored in copies of the core object mapped to various devices. In another embodiment, the storage service 114 stores metadata and data of a core object, while only the data can be replicated and stored in copies of the core object mapped to various devices. In another embodiment, the storage service 114 stores metadata and data of a core object, and both the data and the metadata can be replicated and stored in copies of the core object mapped to various devices.

In one embodiment, a core object is created at storage service 114 upon receiving a creation request. A web-based application at a browser module 102, 104 can submit the request for creation of a core object. In another example, a computer application at the computing device 106, 108 can submit the request for creation of a core object. As such, the identity of the entity requesting the creation of the core object is determined by the application or web-based application. The appropriate storage service that services the specific identity of the user can then be determined.

For example, the storage service 114 can be the service that serves the identity requesting the creation of a core object. The storage service 114 can be configured to create a new core object in association with a unique identifier. The storage service 114 can then create a replica of the core object in the local device, such as computing device 102, 108. The application at computing device 102 can be configured to add the appropriate data to the replicate core object and update it with the storage service 114.

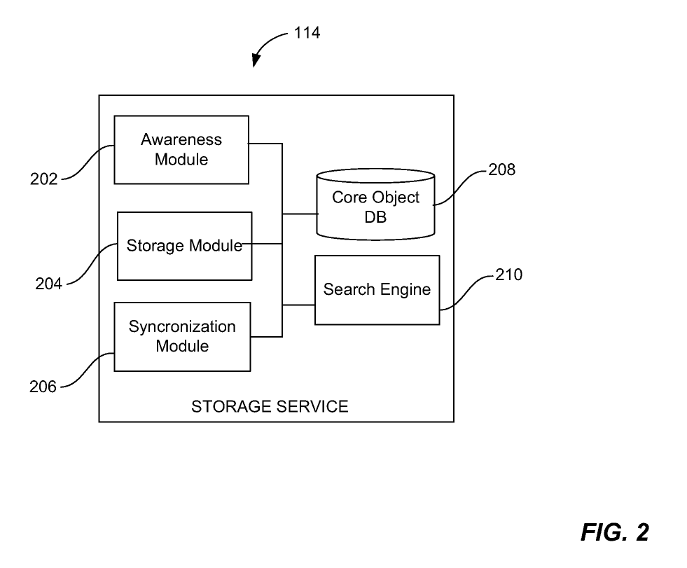

FIG. 2 illustrates a component diagram of a storage service according to one embodiment. The storage service 114 can include one or more functional modules, such as an awareness module 202, a storage module 204, and a synchronization module 206. The storage service 114 can also include a search engine 210.

In one aspect, the storage module 204 can be configured with logic to store metadata or data corresponding to a core object in a core object database 208. The storage module 204 can further be configured to map a core object to a client. As disclosed herein, mapping a core object down to a client device means that the feeds for the core object are replicated to the client device. Depending on the topology and storage properties of each feed, the replication is one-way or two-way. In one example, to map a core object to a client device an entry to the core object mapping feed is added given client device. Determine the type of storage for each feed. Each feed can be set as various types of feed. In one example, if the storage of the feed is set to internal storage, a feed folder can be created under the core object folder. In another example, if the storage of the feed is set to user folder storage, a folder is created in the user space. In another example, if the storage of the feed is set to user file storage, a path to the file is stored in the user space. In another example, if the storage of the feed is set to user data, a folder to hold data is created in the user space.

The awareness module 202 can permit a computing device 106, 108 to subscribe to notifications from the storage service 114. In this sense the computing device 106, 108 can be aware of events that occur to the core object. Thus, the awareness module 202 permits the computing device 106, 108 to subscribe to awareness for each core object. For instance, the awareness module 202 can get notifications whenever any other computing device or entity accesses the core object.

The synchronization module 206 can be configured to synchronize core objects to and from storage service 114. For instance, upon a core object being updated or edited by any computing device, or member, the synchronization module 206 can be configured to update all devices, or members, that are affected by an updated to a give core object. In one embodiment, the synchronization module 206 can be implemented to read the feed of feeds or the core object being synchronized. The synchronization module 206 can then loop over the feeds and synchronize the entries in each feed.

In a further aspect, the search engine 210 can be provided for searching and organizing a user's core object data. In one example, the search engine 210 can be configured to search a core object. Thus, full-text search within a core object, including enclosure data and metadata can be executed by the search engine. In another example, the search engine 210 can be configured to search across all core objects for a user, including data and metadata. In one example, the search engine 210 can be configured to search based on feeds of a core object. In another example, the search engine 210 can be configured to search based on name, type, updated time, published time, etc.

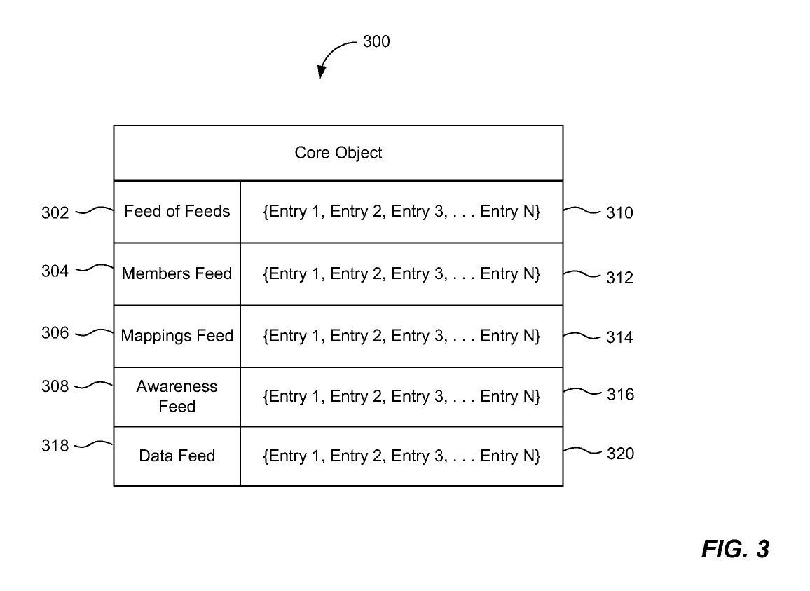

FIG. 3 illustrates an exemplary data structure for a core object 300 according to one embodiment. A core object 300 is a globally unique object that contains some data, that can be accessed by some set of members, and that is mapped to some set of devices. In one implementation, a core object 300 can have a design that describes how the user can interact with the data (including an URL to the application that is best suited to display the core object 300). For instance, the design can be application specific. Although the data for a core object 300 is stored and replicated across (potentially) many devices, the metadata for the core object 300 is stored in a single central storage service 114. Accordingly, core objects are independent unit of storage, replication, synchronization and sharing. As such, computer applications store data in core object 300s, without having to perform any additional functions to replicate or synchronize data. Core objects can be applied for applications that store sets of independent items. For example, a file sharing application (in which each file is an item) can be trivially implemented utilizing a core object 300. In another example, a list application, in which each entry in the list is an independent item, can also be easily implemented on utilizing a core object 300.

A core object 300 can include one or more properties. In one embodiment, the core object 300 is associated with a unique identifier. The unique identifier can be implemented based on a code that is unique across multiple storage services. In another example, the unique identifier can be implemented based on a code that incorporates an indicator of the storage service that manages such core object. For instance, a core object can be universally located by a combination of a storage service URI and a core object identifier. In one embodiment, the unique identifier for a core object is not changed after it is created. In general, the storage service is responsible for assigning unique identifiers to the core objects.

The core object 300 can also include other properties such as title, summary, application type, categories, author, published date, updated date, and feeds. The title can be a non-unique human-readable name for the core object. The summary can be a human-readable description for the core object. The application type can be an application-defined string that describes the application that the core object is associated with. This is generally the application that requested the creation of the core object. In addition, the core object 300 can have zero or more application-defined categories. For instance, the categories can be implemented using ATOM representation. The author property of a core object can identify the user identity that requested the creation of the core object. The published field can be indicative of the date and time on which the core object was created. The updated field can be indicative of the date and time on which the core object was created.

In a further aspect, the core object 300 can include one or more feeds. As disclosed herein, a feed is a set of entries of a type of data. Applications create feeds to store their data. For example, the file system application can create a feed and store the file system data in an enclosure of the feed. Feeds have different properties that allow applications to tailor the feed for their purposes. For example, some feeds are replicated to all members of a core object; other feeds are personal feeds that are accessible only to a single member (e.g., unread marks). A core object can have any number of feeds. An application may create/modify/delete feeds at any time.

A feed can have various properties such as identifier, title, summary, categories, topology, storage, scope, ghosting policy, etc. The identifier of a feed can be a code that is unique to the core object 300. The title can be a non-unique human-readable name for the feed. The summary can be a human-readable description for the feed. In addition, the feeds can have zero or more application-defined categories. For instance, the categories can be implemented using ATOM representation.

In another embodiment, the topology for a feed defines how the entries in the feed may be modified. In one example, the topology can provide the values of cloud and mesh. In cloud-based feeds, the entries in the feed can be modified centrally at the storage service. In other words, this feed uses single-master replication. In mesh-based feeds, the entries in the feed may be modified on any endpoint (i.e., devices can make modifications while offline). This includes creating entries, updating entries, and deleting entries.

In yet another embodiment, a feed can have a storage property that controls how mesh-based feeds store data on client devices. Examples can be internal storage where the structured parts of an entry are stored in the local SQL database for the core object, user folder storage, user file storage and user data storage.

In another embodiment, feeds can also have a scope property that defines the set of members that the feed is relevant to. In one example, possible values include data, personal, design, and membership. Data feeds can be shared by all members. All members have read-write access to the entries in these feeds. Personal feeds are those to which only the owner member has read-write access to their own copy. All other members have no access to other's copies. For example, unread marks are stored in personal feeds. In design feeds, members in the full access role have read-write access to the entries in this feed. All other members have read-only access. In membership feeds, members with invite permission may add entries to the feed. Full access members may modify and delete entries. All others have read-only access.

In one illustrative example, the core object 300 can include a feed of feeds 320, a members feed 304, a mappings feed 306, and an awareness feed 308. The feed of feeds 320 contains entries that describe the feeds of a core object. Entries 310 in the feed of feeds 302 correspond to the descriptor for a feed in the core object 300. An application may create a new feed on a core object 300 by creating a new entry in the feed of feeds 302. Similarly, an application may modify the properties of a feed or delete a feed by manipulating the corresponding entry in the feed of feeds 302.

The members feed 304 can define the set of identities that have access to the core object. As such, the members feed that includes a set of entries 312 indicative of entities that can access the core object. Each entry in the set of entries 3122 can represent either a person or a group who is granted some access role to the core object. The member feed 304 is stored in the storage service 114 and replicated to every device that maps the core object 300. Full-access members may create, read, updated, and delete entries in this feed. Members with the invite capability may create new entries (but the roles/capabilities are limited). All other members may read. In one embodiment, the member feed is only replicated to the storage service 114. The mappings feed 306 defines the set of logical devices to which the core object 300 is mapped. In the awareness feed, 308, each entry 316 represents some awareness information for the core object 300.

In another embodiment, a data feed 318 can be included in the core object 300. The data feed can include a set of entries 320 that include the actual data stored by the core object 300.

A core object's data feed contains the actual user data stored by the core object. For example, in the case of a file system application, the data feed 318 can contain that actual entries for each of the files in the file system. Therefore, the entries 320 are application specific.

In one implementation, when the data feed is replicated to various devices, the items in the data feed may be full or ghosted. Ghosted items contain basic metadata but not large content. For example, in a file system application a ghosted item might contain the filename, modification dates, etc., while a full item would contain the entire file contents. In one example, the data feed 318 can be replicated client to storage service 114 to another client. In another example, the data feed 318 can be replication client-to client.

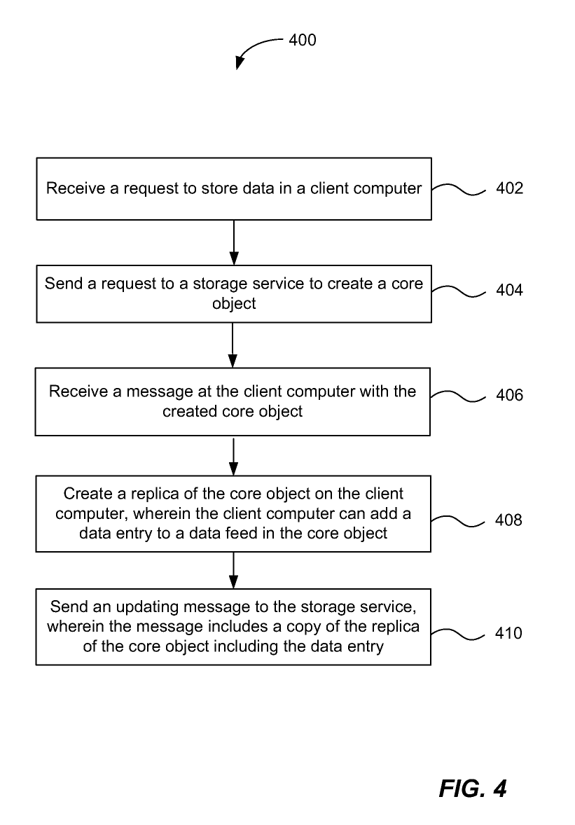

FIG. 4 illustrates a flow diagram of a process for creating and storing a core object according to one embodiment. As previously mentioned, a core object is created on a storage service 114. The storage service for a core object is the authority for all properties and metadata for a core object. In one embodiment, a core object is always created on a storage service and mapped to client devices.

At process block 402, a request to store data in a client computer is received. Process 400 continues at process block 404. At process block 404, a request is sent from the client computer to a storage service to create a core object. The core object can then be created with a member entry to a member feed in the core object. The member feed can be a set of entries associated with the core object. The member feed can be indicative of one or more computing entities that are permitted to access to the core object. The member entry can include a device identifier of the client computer. Process 400 continues at process block 406. At process block 406, a message is received at the client computer with the core object. Process 400 continues at process block 408.

At process block 408, a replica of the core object is created on the client computer. The client computer can add a data entry to a data feed in the core object. The client device can be configured to create the replica by create the appropriate directories. The metadata feed entries and member feed entries can be obtained from the storage service 114. Process 400 continues at process block 410.

At process block 410, an updating message can be sent to the storage service. The message includes a copy of the replica of the core object including a data entry to the data feed.

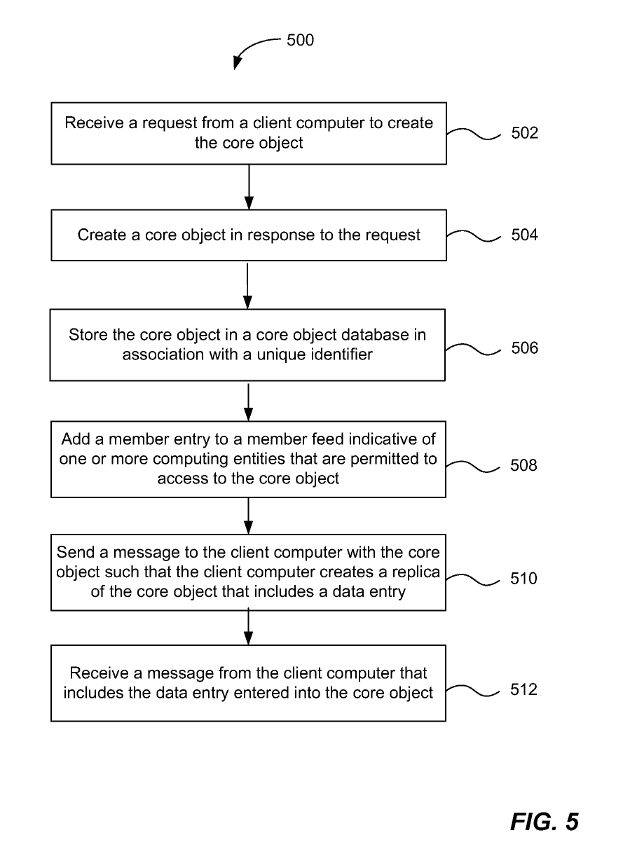

FIG. 5 illustrates a flow diagram of a process for creating and storing a core object according to another embodiment. At process block 502, a request is received from a client computer to create the core object. Process 500 continues at process block 504. At process block 504, a core object can be created in response to the request. Process 500 continues at process block 506.

At process block 506, the core object can be stored in a core object database in association with a unique identifier. Process 500 continues at process block 508.

At process block 508, a member entry is added to a member feed in the core object. The member feed can be a set of entries associated with the core object. The member feed can be indicative of one or more computing entities that are permitted to access to the core object. The member entry can include a device identifier of the client computer from which the request to create the core object was received. Process 500 continues at process block 510.

At process block 510, the core object can be mapped to the client computer by sending a message to the client computer with the core object such that the client computer creates a replica of the core object on the client computer. The client computer can add a data entry to a data feed in the core object. Process 500 continues at process block 512. At process block 512, a message is received from the client computer that includes the data entry entered into the core object.

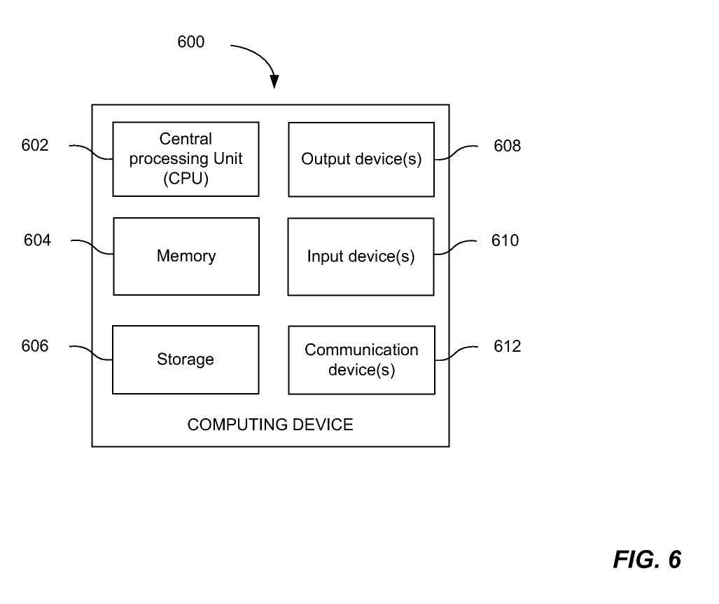

FIG. 6 illustrates a component diagram of a computing device according to one embodiment. The computing device 600 can be utilized to implement one or more computing devices, computer processes, or software modules described herein. In one example, the computing device 600 can be utilized to process calculations, execute instructions, receive and transmit digital signals. In another example, the computing device 600 can be utilized to process calculations, execute instructions, receive and transmit digital signals, receive and transmit search queries, and hypertext, compile computer code, as required by the consumer computing device 106, the merchant computing device 108, the merchant computing device 114, the listing web service 202, the web server 204, and the search engine 206.

The computing device 600 can be any general or special purpose computer now known or to become known capable of performing the steps and/or performing the functions described herein, either in software, hardware, firmware, or a combination thereof.

In its most basic configuration, computing device 600 typically includes at least one central processing unit (CPU) 602 and memory 604. Depending on the exact configuration and type of computing device, memory 604 may be volatile (such as RAM), non-volatile (such as ROM, flash memory, etc.) or some combination of the two. Additionally, computing device 600 may also have additional features/functionality. For example, computing device 600 may include multiple CPU's. The described methods may be executed in any manner by any processing unit in computing device 600. For example, the described process may be executed by both multiple CPU's in parallel.

Computing device 600 may also include additional storage (removable and/or non-removable) including, but not limited to, magnetic or optical disks or tape. Such additional storage is illustrated in FIG. 6 by storage 206. Computer storage media includes volatile and nonvolatile, removable and non-removable media implemented in any method or technology for storage of information such as computer readable instructions, data structures, program modules or other data. Memory 604 and storage 606 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 600. Any such computer storage media may be part of computing device 600.

Computing device 600 may also contain communications device(s) 612 that allow the device to communicate with other devices. Communications device(s) 612 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both computer storage media and communication media. The described methods may be encoded in any computer-readable media in any form, such as data, computer-executable instructions, and the like.

Computing device 600 may also have input device(s) 610 such as keyboard, mouse, pen, voice input device, touch input device, etc. Output device(s) 608 such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

1. A computer-implemented method of storing data at a storage service, comprising:
receiving a request to store data in a client computer;
sending a request from the client computer to a storage service to create a core object such that the core object can be created with a member entry to a member feed in the core object, wherein the member feed is indicative of one or more entities that are permitted to access to the core object;
receiving a message at the client computer with the core object;
creating a replica of the core object on the client computer, wherein the client computer can add the data as a data entry to a data feed in the core object; and
sending an updating message to the storage service, wherein the message includes a copy of the replica of the core object including the data entry.

2. The method of claim 1, wherein the core object is created such that a computer identifier corresponding to the client computer is added as a mappings entry to a mappings feed of the core object, wherein the mappings feed is indicative of one or more device that are permitted to access to the core object.

3. The method of claim 1, wherein the core object is created such that awareness data corresponding to the client computer is added as an awareness entry to a awareness feed of the core object, wherein the awareness feed is indicative of one or more subscribed events regarding the core object.

4. The method of claim 1, further comprising adding personal data as a personal data feed to a personal data feed of the core object, wherein the personal feed is only accessible to the member that originated the request for creation of the core object.

5. The method of claim 1, wherein the core object is created such that design data corresponding to is added as a design entry to a design feed of the core object, wherein the design feed is indicative of application specific design of the core object.

6. The method of claim 1, further comprising adding a title to the core object.

7. The method of claim 1, further comprising adding a description to the core object.

8. The method of claim 1, wherein creating a replica of the core object on the client computer comprises replicating all feeds of the core object.

9. The method of claim 1, wherein creating a replica of the core object on the client computer comprises replicating a subset of the feeds of the core object.

10. The method of claim 1, further comprising retrieving the data by accessing the replica of the core object on the client computer.

11. The method of claim 1, further comprising retrieving the data by accessing the core object in the storage service.

12. A computer-implemented method of storing data at a storage service, comprising:
receiving a request from a client computer to create the core object;
creating a core object in response to the request;
storing the core object in a core object database in association with a unique identifier;
adding a member entry to a member feed in the core object, wherein the member feed is a set of entries associated with the core object, wherein the member feed is indicative of one or more computing entities that are permitted to access to the core object, the member entry including a device identifier of the client computer from which the request to create the core object was received;
mapping the core object to the client computer by sending a message to the client computer with the core object such that the client computer creates a replica of the core object on the client computer, wherein the client computer can add a data entry to a data feed in the core object; and
receiving a message from the client computer that includes the data entry entered into the core object.

13. The method of claim 12, wherein the core object is created such that a computer identifier corresponding to the client computer is added as a mappings entry to a mappings feed of the core object, wherein the mappings feed is indicative of one or more device that are permitted to access to the core object.

14. The method of claim 12, wherein the core object is created such that awareness data corresponding to the client computer is added as an awareness entry to a awareness feed of the core object, wherein the awareness feed is indicative of one or more subscribed events regarding the core object.

15. The method of claim 12, further comprising adding personal data as a personal data feed to a personal data feed of the core object, wherein the personal feed is only accessible to the member that originated the request for creation of the core object.

16. The method of claim 12, wherein the core object is created such that design data corresponding to is added as a design entry to a design feed of the core object, wherein the design feed is indicative of application specific design of the core object.

17. The method of claim 12, further comprising adding a title to the core object.

18. The method of claim 12, further comprising adding a description to the core object.

19. The method of claim 12, wherein creating a replica of the core object on the client computer comprises replicating all feeds of the core object.

20. The method of claim 12, wherein creating a replica of the core object on the client computer comprises replicating a subset of the feeds of the core object.

21. A computer-readable medium that includes a core object data structure, comprising:
a metadata feed that includes a set of entries indicative of metadata associated with the core object;
a members feed that includes a set of entries indicative of entities that can access the core object;
a mappings feed that includes a set of entries indicative of devices in which the core object is replicated; and
a data feed that includes a set of entries that include the actual data stored by the core object.
